(19) United States
(12) Patent Application Publication
(10) Pub. No.: US 2022/0243778 A1
(43) Pub. Date: Aug. 4, 2022

(54) BRAKE PAD WEAR LEVEL MONITORING

(71) Applicant: SENSATA TECHNOLOGIES, INC., ATTLEBORO, MA (US)

(72) Inventors: NICHOLAS J. HEEDER, NARRAGANSETT, RI (US); NASHIRU ALHASSAN, PAWTUCKET, RI (US); ADITYA BALASUBRAMANIAN, JOHNSTON, RI (US); MARK DUFFY, ANTRIM (GB); NEVIN R. MOLYNEAUX, CRUMLIN (GB)

(21) Appl. No.: 17/585,681

(22) Filed: Jan. 27, 2022

Related U.S. Application Data
(60) Provisional application No. 63/143,251, filed on Jan. 29, 2021.

(51) Int. Cl. F16D 66/02; B60T 17/22; G01M 5/00

(52) U.S. Cl. CPC F16D 66/027; B60T 17/221; F16D 2066/001; G01M 5/0091; G01M 5/0033; F16D 66/028

(57) ABSTRACT

Methods, apparatus, systems, and computer program products for brake pad wear level monitoring are disclosed. In a particular embodiment, an apparatus for brake pad wear level monitoring includes a sensor module attached to a fixed portion of a braking system. In this embodiment, the sensor module is configured to generate data indicative of a relative distance between the sensor module and a sensor target attached to a brake pad. According to this embodiment, the sensor module is also configured to use the generated data generate transmission data and transmit the generated transmission data to an external device.

### CROSS-REFERENCE TO RELATED APPLICATIONS

This application is a non-provisional application for patent entitled to a filing date and claiming the benefit of earlier-filed U.S. Provisional Patent Application Ser. No. 63/143,251, filed Jan. 29, 2021, the contents of which are herein incorporated by reference in their entirety.

### BACKGROUND

Without a sensor for determining the wear of a brake pad, drivers are forced to remove one or more tires from their vehicle to determine the level of wear on their brake pads. The typical current market application for brake pad wear sensing consists of a device that indicates when the pad has sufficient wear to warrant replacement. The “sensor” typically consists of a wire that is broken when the pad wear reaches the point of the sensor causing the wire to be consumed during the braking process and leading to an open circuit. The open circuit is then used to indicate a light on the vehicle dash indicating that the brake pads need replacing. The sensor is consumed during the operational life of the brake pads and must be replaced when the brake pads are replaced at additional owner cost. Further, the wire harness for the brake pad wear sensor described above must be included in the vehicle architecture. This includes the complicated routing of a wire in the moving wheel suspension system as well as consuming connection points on vehicle system modules for the data acquisition.

### SUMMARY

This summary is provided to introduce a selection of concepts that are further described below in the detailed description. This summary is not intended to identify essential features of the claimed subject matter, nor is it intended to be used as an aid in limiting the scope of the claimed subject matter.

In the present disclosure, methods, apparatus, systems, and computer program products for brake pad wear level monitoring are disclosed. In a particular embodiment, an apparatus for brake pad wear level monitoring includes a sensor module attached to a fixed portion of a braking system. In this embodiment, the sensor module is configured to generate data indicative of a relative distance between the sensor module and a sensor target attached to a brake pad. The sensor module is also configured to use the generated data to generate transmission data and transmit the generated transmission data to an external device.

In another embodiment, a method of brake pad wear level monitoring includes a sensor module, which is attached to a fixed portion of a braking system, generating data indicative of a relative distance between the sensor module and a sensor target that is attached to a brake pad. In this embodiment, the sensor module uses the generated data to determine a wear level of the brake pad.

In another embodiment, a method of brake pad wear level monitoring includes a wear level monitor of a sensor module receiving from a sense element of a sensor module, data indicative of a relative distance between the sensor module and a sensor target that is attached to a brake pad. In this embodiment, the wear level monitor uses the generated data to determine a wear level of the brake pad.

In another embodiment, an apparatus for brake pad wear level monitoring is disclosed. In this embodiment, the apparatus includes a computer processor coupled to a non-transitory computer readable storage medium that includes computer program instructions that when executed by the computer processor cause the apparatus to carry out the operations of: receiving, by a wear level monitor, transmission data from a sensor module attached to a fixed position of a braking system; and using, by the wear level monitor, the transmission data to determine a wear level of a brake pad of the braking system.

An advantage of brake pad wear level monitoring in accordance with one or more embodiments of the present disclosure is that the current state of the wear level of the brake pad may be identified without the need for removing a wheel of the vehicle. Another advantage of the sensor module described in the present disclosure is that the sensor module may be easily integrated with existing braking systems and is not required to be removed when the user changes their brakes.

Furthermore, by continually monitoring the relative distance between the sensor module and the sensor target, the sensor module may regularly track and provide outputs to a driver or vehicle system regarding the current brake pad wear level. Regular updates regarding brake pad wear may enable a driver or vehicle system to stay informed about the current state of the brake pad wear. As will be explained further below, a system that continually monitors brake pad wear level is an improvement over the prior monitoring sensors. In addition, the generated wear level monitoring data may also be useful for vehicle manufacturers and dealerships. For example, a vehicle manufacturer or dealer may use the monitoring data to better time incentives offered to the vehicle owner. Furthermore, continually monitoring brake pad wear can be useful to diagnose brake faults that cause premature pad wear, such as a sticky caliper/piston.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF DRAWINGS

FIG. 1 illustrates a braking system configured for brake pad wear level monitoring according to at least one embodiment of the present disclosure;

FIG. 2A illustrates a sensor module of a brake pad wear level monitoring sensor according to at least one embodiment of the present disclosure;

FIG. 2B illustrates a sensor target of a brake pad wear level monitoring sensor according to at least one embodiment of the present disclosure;

FIG. 3A illustrates a block diagram of a sensor module configured for brake pad wear level monitoring in accordance with at least one embodiment of the present disclosure;

FIG. 3B illustrates a block diagram of an external device configured for brake pad wear level monitoring in accordance with at least one embodiment of the present disclosure;

FIG. 4 is a flowchart of an example method for brake pad wear level monitoring in accordance with at least one embodiment of the present disclosure;

FIG. 5 is a flowchart of an example method for brake pad wear level monitoring in accordance with at least one embodiment of the present disclosure;

FIG. 6 is a flowchart of an example method for brake pad wear level monitoring in accordance with at least one embodiment of the present disclosure;

FIG. 7 is a flowchart of an example method for brake pad wear level monitoring in accordance with at least one embodiment of the present disclosure;

FIG. 8 is a flowchart of an example method for brake pad wear level monitoring in accordance with at least one embodiment of the present disclosure;

FIG. 9 is a flowchart of an example method for brake pad wear level monitoring in accordance with at least one embodiment of the present disclosure;

FIG. 10 is a flowchart of an example method for brake pad wear level monitoring in accordance with at least one embodiment of the present disclosure;

FIG. 11 is a flowchart of an example method for brake pad wear level monitoring in accordance with at least one embodiment of the present disclosure;

FIG. 12 is a flowchart of an example method for brake pad wear level monitoring in accordance with at least one embodiment of the present disclosure;

FIG. 13 is a flowchart of an example method for brake pad wear level monitoring in accordance with at least one embodiment of the present disclosure;

FIG. 14 is a flowchart of an example method for brake pad wear level monitoring in accordance with at least one embodiment of the present disclosure; and

FIG. 15 is a flowchart of an example method for brake pad wear level monitoring in accordance with at least one embodiment of the present disclosure.

### DESCRIPTION OF EMBODIMENTS

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

As will be discussed in greater detail below, embodiments of the present disclosure include a wireless brake pad wear sensor (WBPWS) configured to measure brake pad wear on fixed-opposed piston caliper systems.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

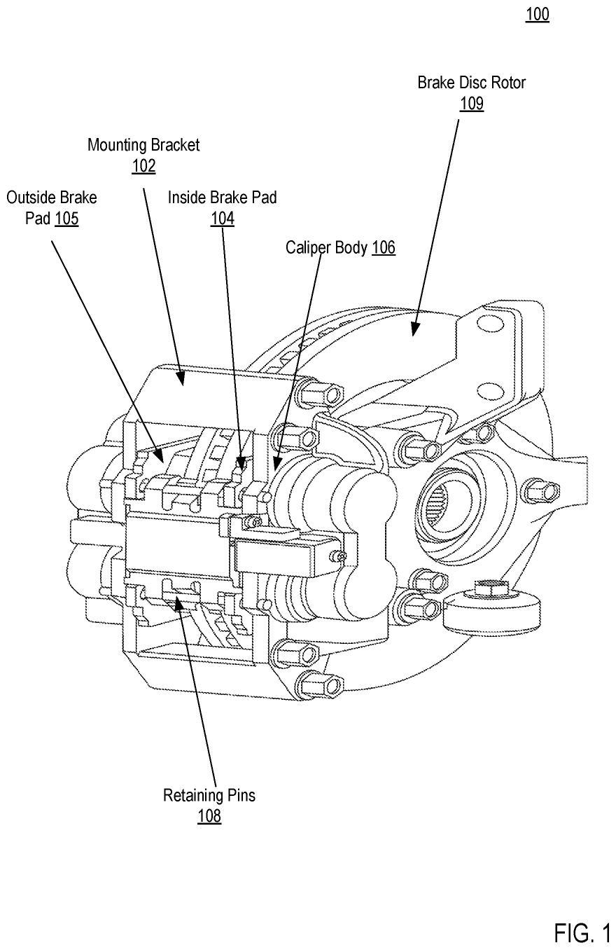

Exemplary methods, apparatuses, and computer program products for brake pad wear level monitoring in accordance with the present disclosure are described with reference to the accompanying drawings, beginning with FIG. 1. FIG. 1 sets forth a brake system (100) configured for brake pad wear level monitoring according to at least one embodiment of the present disclosure. In the example of FIG. 1, the brake system (100) is a fixed-opposed piston caliper brake system, but readers of skill in the art will realize that any number of alternative brake system configurations may utilize brake pad wear level monitoring in accordance with embodiments of the present disclosure.

During typical operation of disc brake system, a caliper is fed brake fluid by a brake fluid line (not pictured), which drives all pistons within the caliper forward, causing both an inside brake pad (104) and an outside brake pad (105) to move along retainer pins (108) towards the disc rotor (109). In this example fixed-opposed caliper brake system (100), a caliper body (106) and a mount bracket (102) remain stationary at all times. Contact between the brake disc rotor (109) and the brake pads (104, 105) will cause the brake pads (104, 105) to wear down.

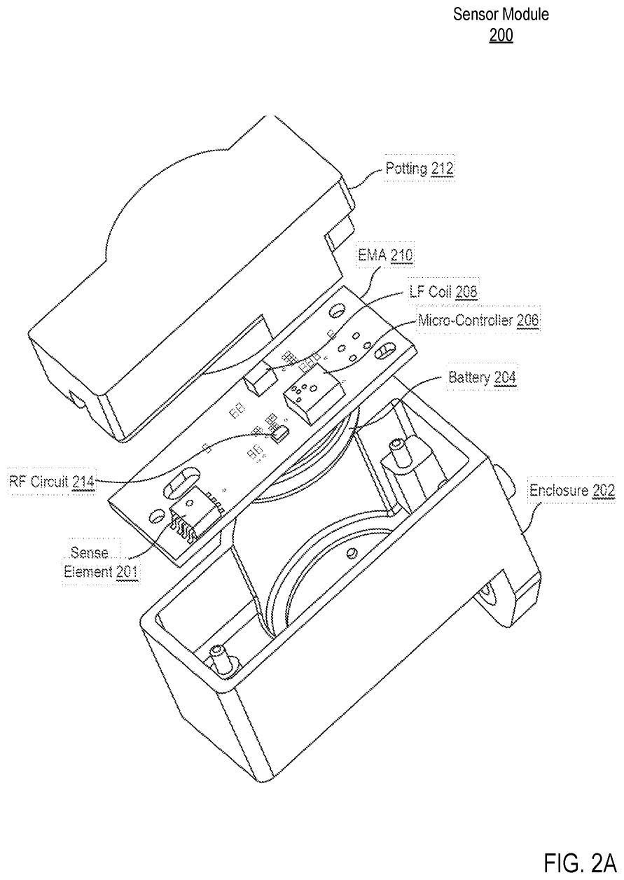

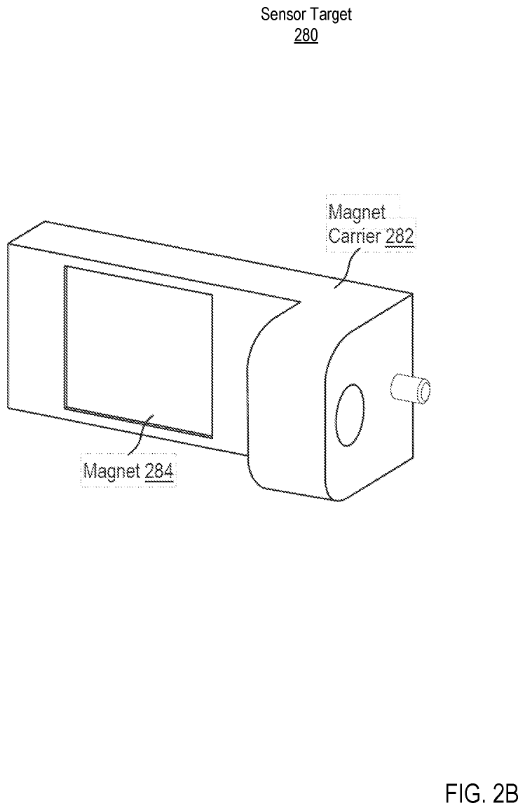

To determine and monitor the wear level of the brake pad, a brake pad wear level monitoring sensor may be attached to the components of the brake system. A brake pad wear level monitoring sensor may include a sensor module and a sensor target. For further explanation, FIG. 2A sets forth an example sensor module (200) of a brake pad wear level monitoring sensor and FIG. 2B sets forth an example sensor target (280) of a brake pad wear level monitoring sensor. The sensor target (280) includes a magnet (284) within a magnet carrier (282). The sensor target (280) is configured to be coupled to a moveable component of the brake system, such as a brake pad backing plate or brake pad (e.g., brake pads (104, 105) of FIG. 1).

The sensor module (200) of FIG. 2A includes a sense element (201) attached to a Electronic Module Assembly (EMA) (210) having printed circuit board (PCB) with a LF coil (208), a micro-controller (206), an RF circuit (214), and a battery (204). The EMA (210) is encased by an enclosure (202) and a potting (212). The sensor module (200) is configured to be attached to some fixed component of the brake system, such as the caliper body/housing (106) or mounting bracket (102) of FIG. 1.

The sense element (201) is configured to generate data indicative of a relative distance between the sensor module and the sensor target. Examples of a sense element include but are not limited to a magneto resistive element, an inductive element, or two or more low-power resistive bridge elements in a wheatstone configuration. In a particular embodiment, the sense element (201) is configured to detect a strength of the magnetic field of the magnet (284) of the sensor target (280) and generate a signal indicating the strength of the magnetic field and thus the relative distance between the sensor module and the sensor target. In this embodiment, the micro-controller (206) uses this data indicating the relative distance between the sensor module and the sensor target to generate transmission data. As will be explained in further detail below, transmission data, as used in this application, may include but is not limited to position data, such as the generated data indicative of the relative distance between the sensor module and the sensor target; a modified/converted form of the generated data; data that is otherwise based on the generated data; an indication of wear level; or some combination of position data and an indication of wear level of a brake pad.

In a particular embodiment, the sensor module may use the generated data to determine a wear level of the brake pad. For example, the sensor module may use a data structure that correlates relative distance between the sensor module and the sensor target to brake pad wear. In this embodiment, the transmission data may include an indication of the determined wear level of the brake pad. Alternatively, the sensor module may transmit position data as transmission data without determining a wear level of the brake pad. In this embodiment, the external device may utilize the position data in the transmission data to determine a wear level of the brake pad.

In some embodiments, an alternative sensing technology, inductive sensing, can be used to measure the relative position between the caliper and at least one of the brake pads. In this configuration, the sensor module would again be attached to the caliper body/housing, which senses the position of a metallic target that is either integrated into the brake pad assembly or retrofitted to the original brake assembly. In some embodiments, the EMA contained within the sensor module may contain an inductive sense element configured to generate a signal having a strength correlative to a displacement between the sensor assembly and the metallic reference portion.

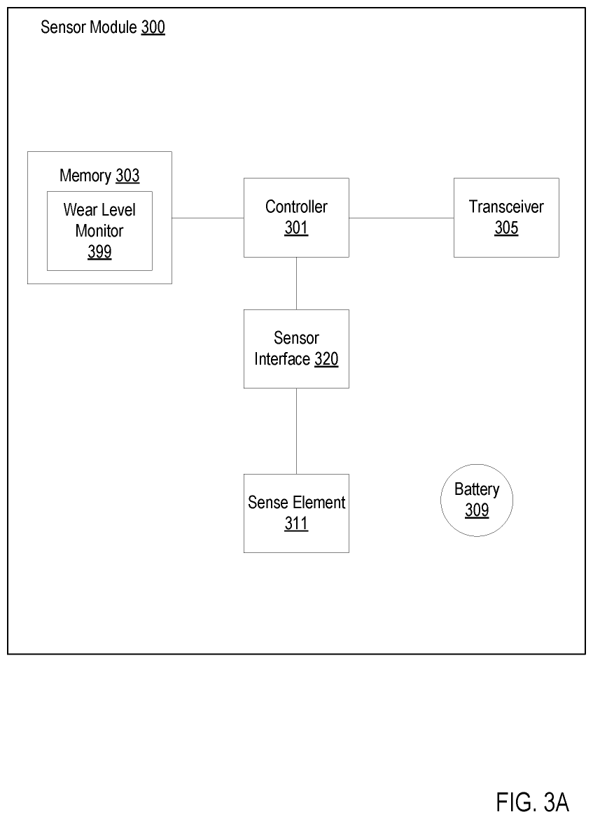

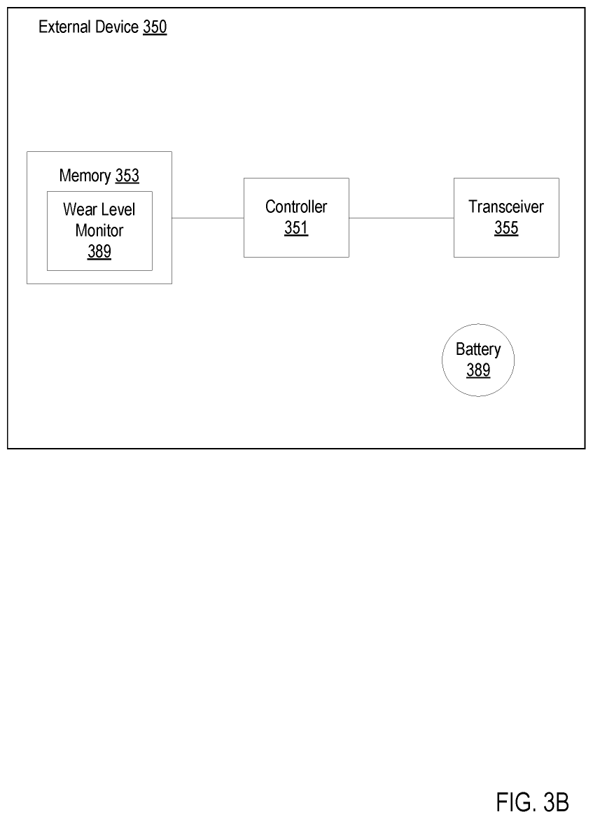

For further explanation, FIG. 3A sets forth a block diagram of a sensor module (300) configured for brake pad wear level monitoring in accordance with at least one embodiment of the present disclosure. The sensor module (300) includes a battery (309) and a controller (301) coupled to memory (303), a transceiver (305), and a sensor interface (320) for connecting to a sense element (311).

In the example of FIG. 3A, the memory (303) includes a wear level monitor (399) having computer program instructions that when executed by the controller (301) cause the controller (301) to carry out the operations of generating data indicative of a relative distance between the sensor module and a sensor target attached to a brake pad; using the generated data to generate transmission data; and transmit the generated transmission data to an external device.

In a particular embodiment, the wear level monitor (399) may also include computer program instructions that when executed by the controller (301) cause the controller (301) to carry out the operations of receiving from the sense element (311) data indicative of a relative distance between the sensor module and a sensor target attached to a brake pad; and using the received data to determine a wear level of the brake pad.

For further explanation, FIG. 3B sets forth a block diagram of an external device (350) configured for brake pad wear level monitoring in accordance with at least one embodiment of the present disclosure. Examples of external devices that may be configured to receive the transmitted wear level include but are not limited to an electronic control module (ECM) of a vehicle; a mobile device; and a diagnostic tool. The external device (350) includes a battery (389) and a controller (351) coupled to memory (353) and a transceiver (355).

In the example of FIG. 3B, the memory (353) includes a wear level monitor (389) having computer program instructions that when executed by the controller (351) cause the controller (351) to carry out the operations of receiving, by the wear level monitor (389), transmission data from a sensor module (e.g., the sensor module (300) of FIG. 3) attached to a fixed position of a braking system; and using, by the wear level monitor (389), the transmission data to determine a wear level of a brake pad of the braking system.

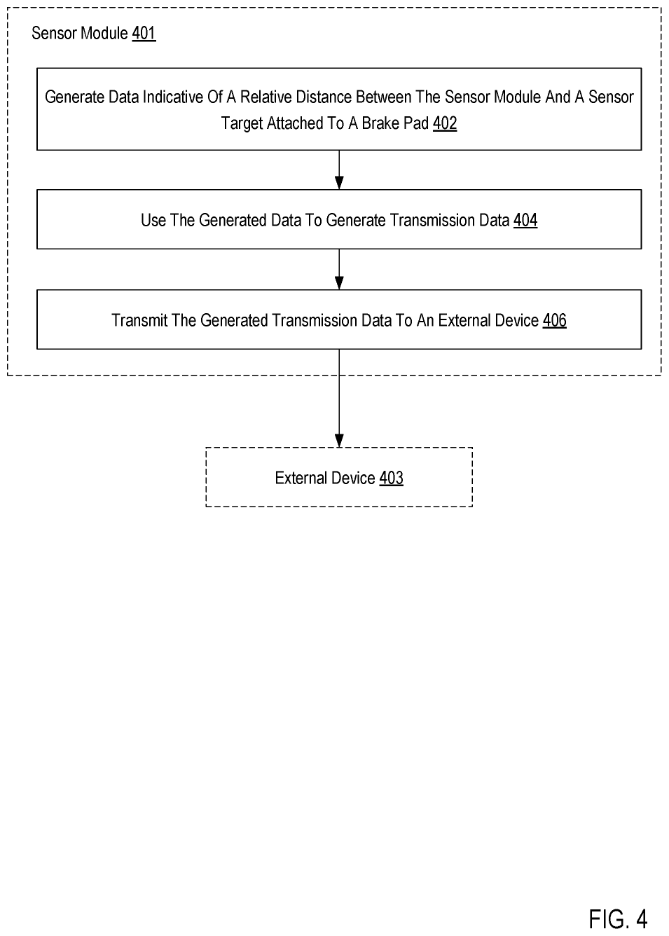

For further explanation, FIG. 4 sets forth a flowchart of an example method for brake pad wear level monitoring in accordance with at least one embodiment of the present disclosure. The method of FIG. 4 includes generating (402), by a sensor module (401) attached to a fixed portion of a braking system, data indicative of a relative distance between the sensor module and a sensor target attached to a brake pad. Generating (402), by a sensor module (401) attached to a fixed portion of a braking system, data indicative of a relative distance between the sensor module and a sensor target attached to a brake pad may be carried out by using the sense element to measure a magnetic field of a magnet in a sensor target; and utilizing inductive sensing to measure the relative position of a metallic target integrated into a brake pad or assembly.

The method of FIG. 4 also includes using (404), by the sensor module (401), the generated data to generate transmission data. Examples of transmission data include but are not limited to position data, such as the generated data indicative of the relative distance between the sensor module and the sensor target; a modified/converted form of the generated data; or data that is otherwise based on the generated data. In a particular embodiment, the sensor module may use the generated data to determine a wear level of the brake pad. For example, the sensor module may use a data structure that correlates relative distance between the sensor module and the sensor target to brake pad wear. In this embodiment, the transmission data may include an indication of the determined wear level of the brake pad.

In addition, the method of FIG. 4 also includes transmitting (406), by the sensor module, the generated transmission data to an external device. As used in this application, an external device may be any device that is external to the sensor module and capable of receiving the transmitted wear level. Examples of external devices that may be configured to receive the transmitted wear level include but are not limited to an electronic control module (ECM) of a vehicle; a mobile device; and a diagnostic tool. Transmitting (406), by the sensor module, the generated transmission data to an external device may be carried out by utilizing a wirelessly radio frequency (RF) transmitter to broadcast a signal that includes the generated transmission data.

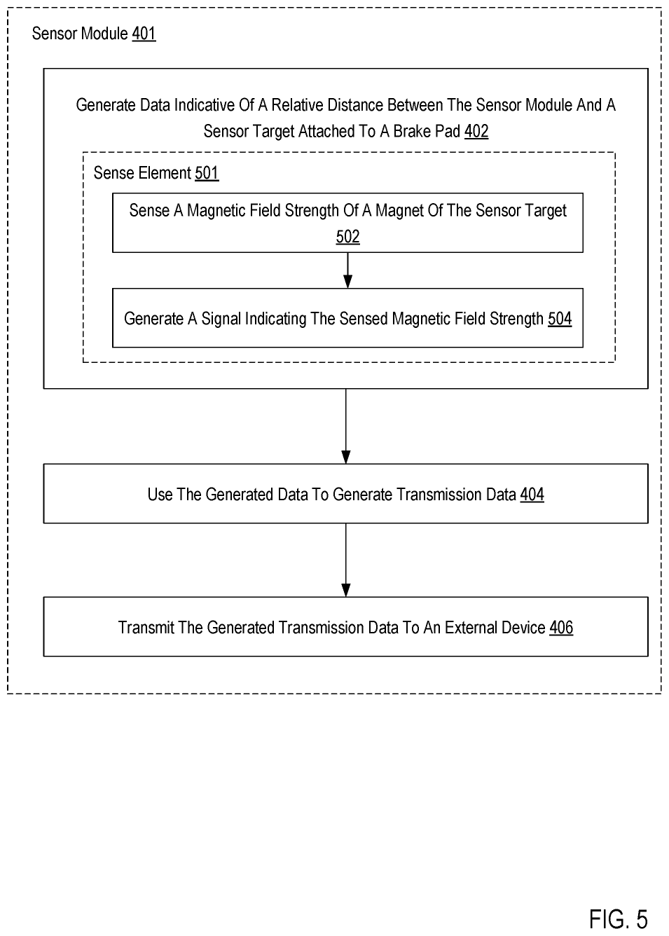

For further explanation, FIG. 5 sets forth a flowchart of an example method for brake pad wear level monitoring in accordance with at least one embodiment of the present disclosure. The method of FIG. 5 includes the elements of FIG. 4. In the method of FIG. 5, generating (402) data indicative of a relative distance between the sensor module and a sensor target attached to a brake pad includes sensing (502), by a sense element (501) of the sensor module, a magnetic field strength of a magnet of the sensor target attached to the brake pad. Sensing (502), by a sense element (501) of the sensor module, a magnetic field strength of a magnet of the sensor target attached to the brake pad may be carried out by determining a change in resistance of a magneto resistive element.

In the method of FIG. 5, generating (402) data indicative of a relative distance between the sensor module and a sensor target attached to a brake pad includes generating (504), by the sense element (501), a signal indicating the sensed magnetic field strength. Generating (504), by the sense element (501), a signal indicating the sensed magnetic field strength may be carried out by translating the measurement of the magnetic field into a digital signal for transmission to a micro-controller or processor.

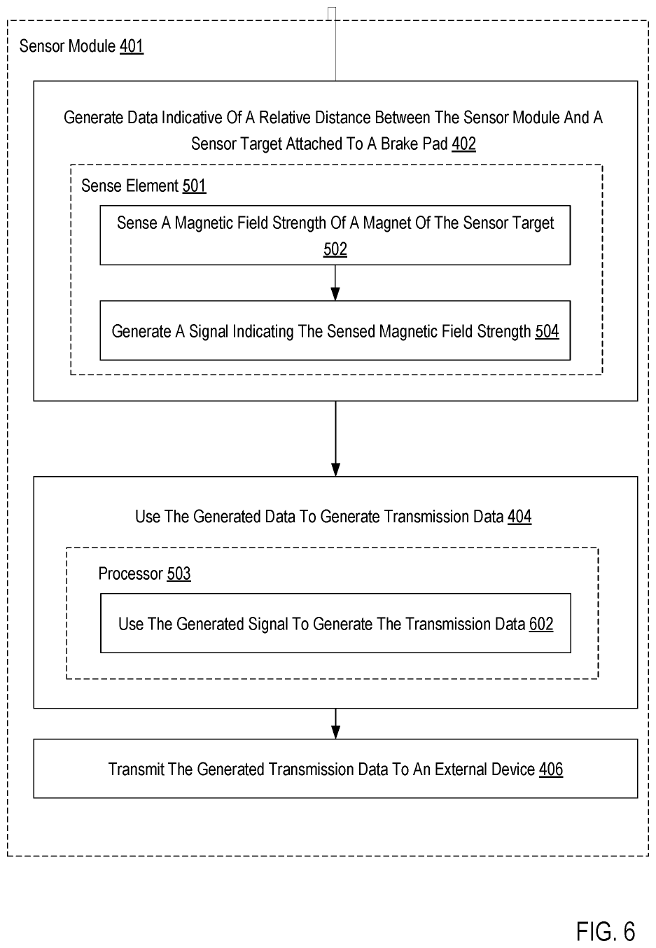

For further explanation, FIG. 6 sets forth a flowchart of an example method for brake pad wear level monitoring in accordance with at least one embodiment of the present disclosure. The method of FIG. 6 includes the elements of FIG. 5. In the method of FIG. 6, using (404) the generated data to generate transmission data includes using (602) the generated signal to generate the transmission data. Using (602), by a processor (601) of the sensor module (401), the signal to determine the wear level of the brake pad may be carried out by converting the generated signal into a form of data for transmission; using information from the signal to lookup or correlate the information to a wear level.

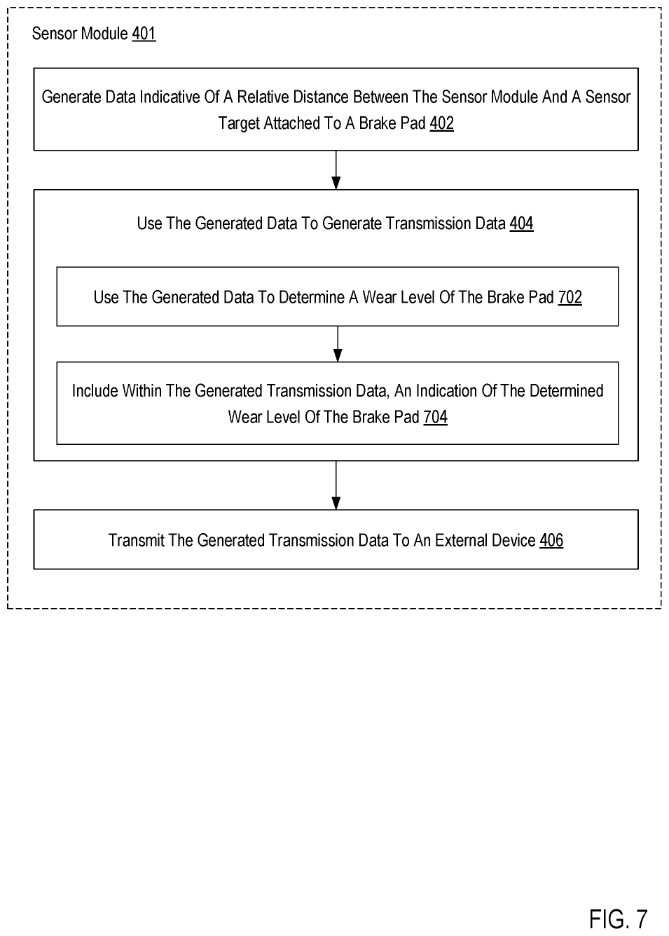

For further explanation, FIG. 7 sets forth a flowchart of an example method for brake pad wear level monitoring in accordance with at least one embodiment of the present disclosure. The method of FIG. 7 includes the elements of FIG. 4. In the method of FIG. 7, using (402) the generated data to generate transmission data includes using (702) the generated data to determine a wear level of the brake pad. Using (702) the generated data to determine a wear level of the brake pad may be carried out by using a data structure that correlates relative distance between the sensor module and the sensor target to brake pad wear.

In addition, in the example of FIG. 7, using (402) the generated data to generate transmission data includes including (704) within the generated transmission data, an indication of the determined wear level of the brake pad. Including (704) within the generated transmission data, an indication of the determined wear level of the brake pad may be carried out by including the determined wear level in the transmission data; and converting or otherwise modifying the determined wear level into an indication of the determined wear level that is included in the generated transmission data.

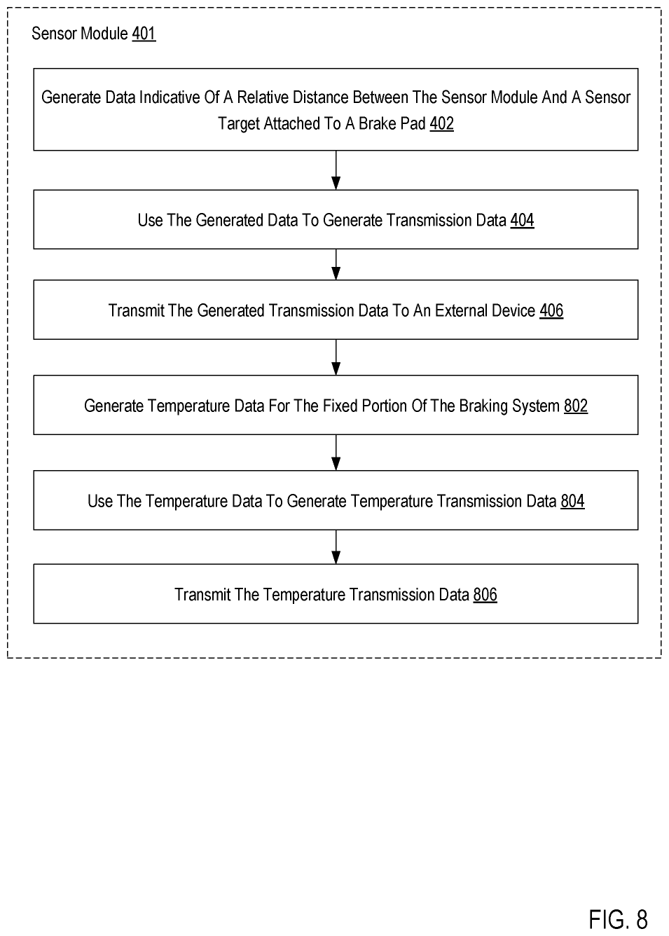

For further explanation, FIG. 8 sets forth a flowchart of an example method for brake pad wear level monitoring in accordance with at least one embodiment of the present disclosure. The method of FIG. 8 includes generating (802) temperature data for the fixed portion of the braking system. Generating (802) temperature data for the fixed portion of the braking system may be carried out by receiving temperature data from a temperature sensor that is part of the sensor module or coupled to the sensor module. Because the sensor module is coupled to a fixed portion of the braking system, the temperature data may be indicative of a temperature of the fixed portion of the braking system.

In addition, the method of FIG. 8 includes using (804) the temperature data to generate temperature transmission data. Examples of transmission data include but are not limited to temperature data, such as the generated temperature data; a modified/converted form of the generated temperature data; or data that is otherwise based on the generated temperature data. Using (804) the temperature data to generate temperature transmission data may be carried out by including the temperature data in the temperature transmission data; and converting or otherwise modifying the temperature data to generate the temperature transmission data.

The method of FIG. 8 also includes transmitting (806) the temperature transmission data. Transmitting (806) the temperature transmission data may be carried out by utilizing a wirelessly radio frequency (RF) transmitter to broadcast a signal that includes the temperature transmission data. In a particular embodiment, an external device, such as the external device (350) of FIG. 3B may be configured to receive and process both the temperature transmission data and the transmission data. In another embodiment, a first set of one or more external devices may be configured to receive and process the transmission data and a second set of one or more external devices may be configured to receive and process the temperature transmission data.

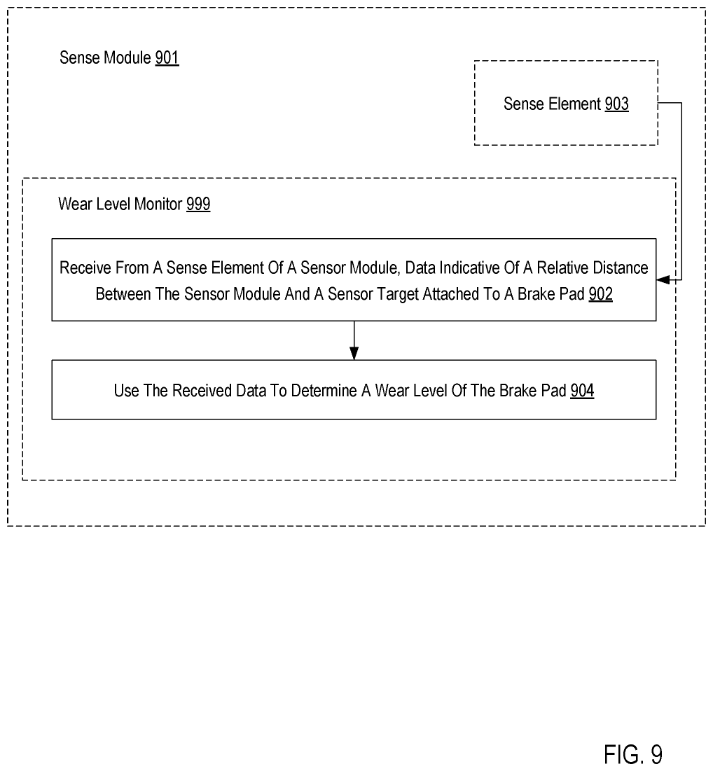

For further explanation, FIG. 9 sets forth a flowchart of an example method for brake pad wear level monitoring in accordance with at least one embodiment of the present disclosure. The method of FIG. 9 includes receiving (902) from a sense element (903) of a sensor module (901), by a wear level monitor (999) of the sensor module (901), data indicative of a relative distance between the sensor module and a sensor target attached to a brake pad. Receiving (902) from a sense element (903) of a sensor module (901), by a wear level monitor (999) of the sensor module (901), data indicative of a relative distance between the sensor module and a sensor target attached to a brake pad may be carried out by receiving data that measures a magnetic field of a magnet in a sensor target.

In addition, the method of FIG. 9 also includes using (904), by the wear level monitor (999), the generated data to determine a wear level of the brake pad. Using (904), by the wear level monitor (999), the generated data to determine a wear level of the brake pad may be carried out by using a data structure that correlates relative distance between the sensor module and the sensor target to brake pad wear.

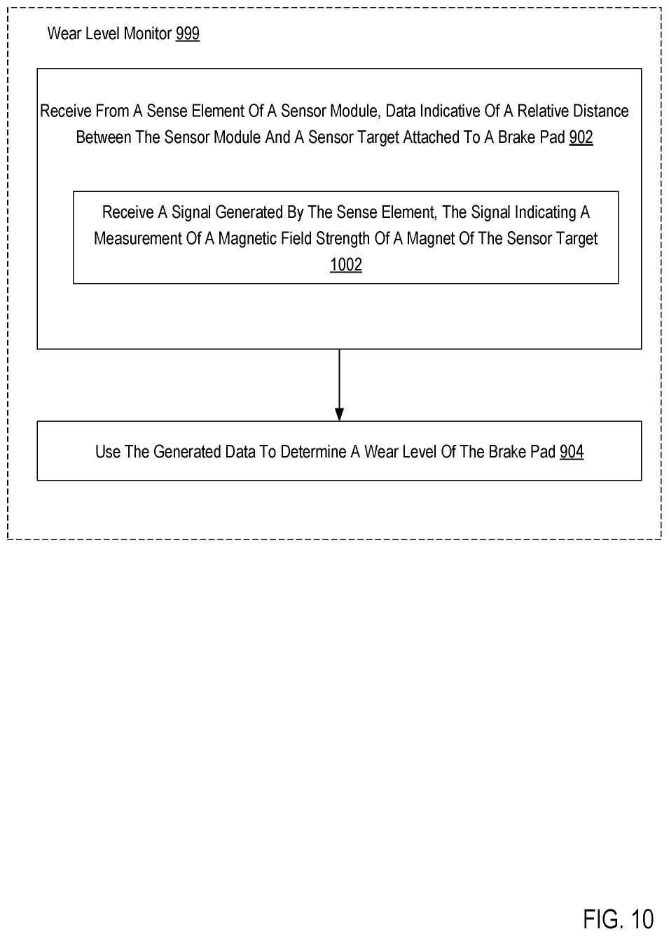

For further explanation, FIG. 10 sets forth a flowchart of an example method for brake pad wear level monitoring in accordance with at least one embodiment of the present disclosure. The method of FIG. 10 includes elements of FIG. 9. In the method of FIG. 10, receiving (902) from a sense element (903) of a sensor module (901), by a wear level monitor (999) of the sensor module (901), data indicative of a relative distance between the sensor module and a sensor target attached to a brake pad includes receiving a signal generated by the sense element, the signal indicating a measurement of a magnetic field strength of a magnet of the sensor target. Receiving a signal generated by the sense element, the signal indicating a measurement of a magnetic field strength of a magnet of the sensor target may be carried out by receiving data indicating a change in resistance of a magneto resistor within the sense element.

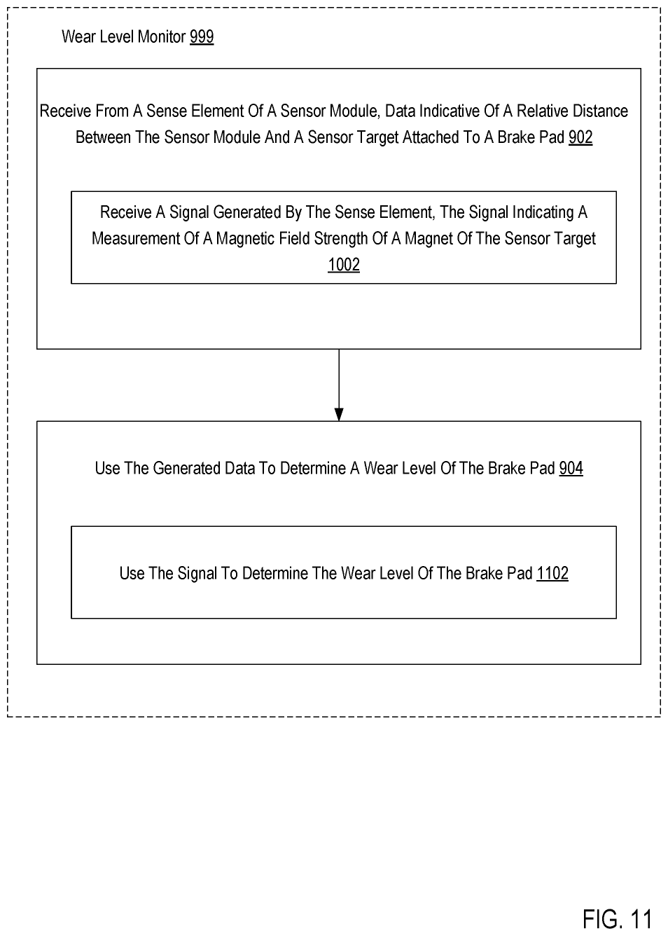

For further explanation, FIG. 11 sets forth a flowchart of an example method for brake pad wear level monitoring in accordance with at least one embodiment of the present disclosure. The method of FIG. 11 includes elements of FIG. 10. In the method of FIG. 11, using (904) the generated data to determine a wear level of the brake pad includes using (1102) the signal to determine the wear level of the brake pad. Using (1102) the signal to determine the wear level of the brake pad may be carried out by using information from the signal to lookup or correlate to a wear level.

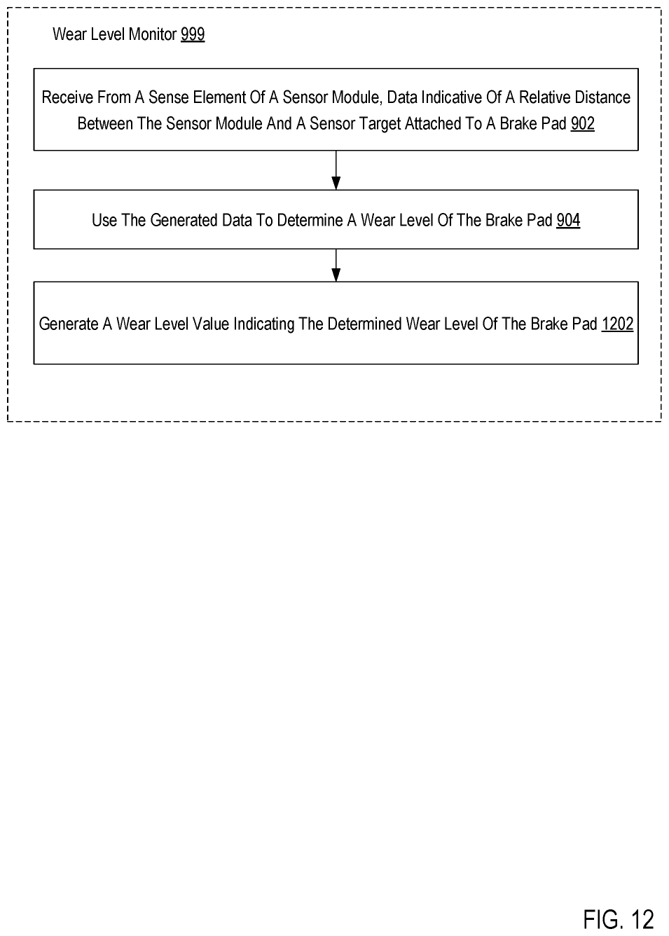

For further explanation, FIG. 12 sets forth a flowchart of an example method for brake pad wear level monitoring in accordance with at least one embodiment of the present disclosure. The method of FIG. 12 includes elements of FIG. 9. In addition, the method of FIG. 12 also includes generating (1202), by the wear level monitor (999), a wear level value indicating the determined wear level of the brake pad. Generating (1202), by the wear level monitor (999), a wear level value indicating the determined wear level of the brake pad may be carried out by converting the determined wear level to a wear level value for transmitting or outputting.

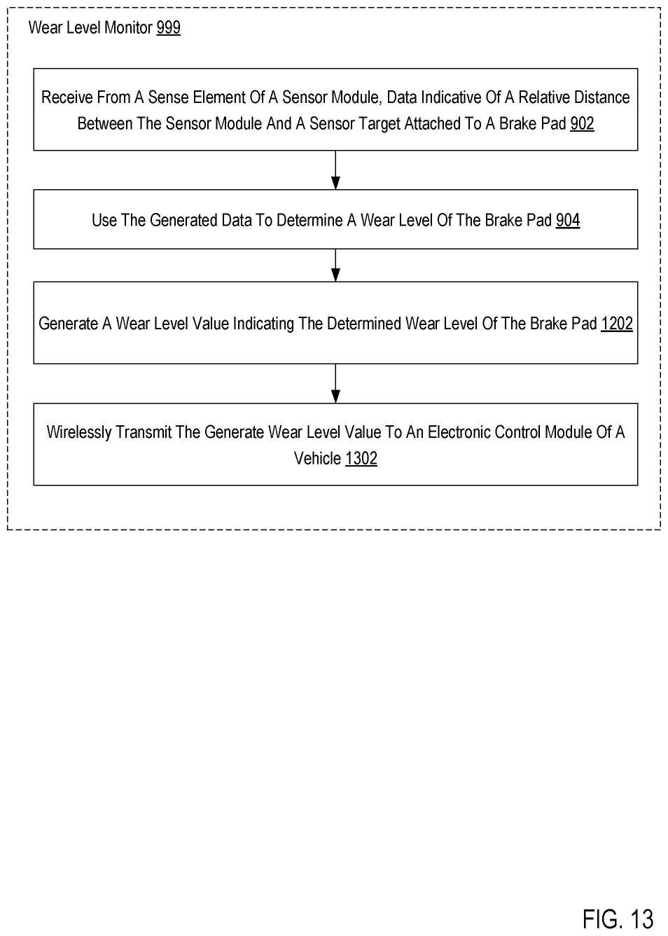

For further explanation, FIG. 13 sets forth a flowchart of an example method for brake pad wear level monitoring in accordance with at least one embodiment of the present disclosure. The method of FIG. 13 includes elements of FIG. 9. In addition, the method of FIG. 13 also includes wirelessly transmitting (1302), by the wear level monitor (999), the generated wear level value to an electronic control module of a vehicle. Wirelessly transmitting (1302), by the wear level monitor (999), the generated wear level value to an electronic control module of a vehicle may be carried out by utilizing a wirelessly radio frequency (RF) transmitter to broadcast a signal that includes the data associated with the generated wear level value.

In a particular embodiment, an ECU is configured to control one or more vehicle subsystems. Commonly referred to as the vehicle's “computers”, an ECU may be a vehicle subsystem control units, such as an Engine Control Module (ECM), a Powertrain Control Module (PCM), a Transmission Control Module (TCM), a Brake Control Module (BCM), a Central Timing Module (CTM), a General Electronic Module (GEM), a Suspension Control Module (SCM). In a particular embodiment, the ECU may be considered a Vehicle Control Unit (VCU) that controls one or more other ECUs.

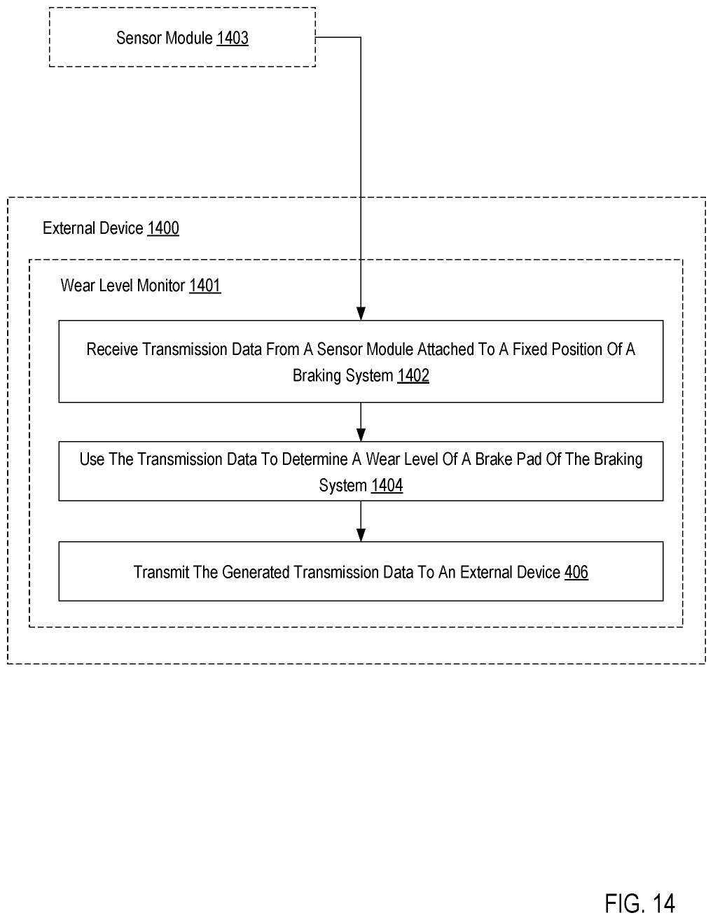

For further explanation, FIG. 14 sets forth a flowchart of an example method for brake pad wear level monitoring in accordance with at least one embodiment of the present disclosure. The method of FIG. 14 includes receiving (1402), by a wear level monitor (1401) of an external device (1400), transmission data from a sensor module (1403) attached to a fixed position of a braking system. Examples of transmission data may include but are not limited to position data indicative of a relative distance between the sensor module and a sensor target attached to a brake pad; and an indication of a wear level of a brake pad. In a particular embodiment, the external device receives transmission data indicating a wear level of the brake pad. In other embodiments, the external device receives transmission data that includes raw data, such as position data, and the external device uses the transmission data to identify a wear level of the brake pad.

In addition, the method of FIG. 14 also includes using (1404), by the wear level monitor (1401), the transmission data to determine a wear level of a brake pad of the braking system. Using (1404), by the wear level monitor (1401), the transmission data to determine a wear level of a brake pad of the braking system may be carried out by retrieving from the transmission data, an indication of the wear level of the brake pad and using the indication to determine the wear level of the brake pad. In another embodiment, the wear level monitor may convert or modify position data within the transmission data to determine a wear level of the brake pad.

In a particular embodiment, the wear level monitor may receive temperature transmission data from the sensor module and use the temperature transmission data to determine and report to a user, a temperature of a fixed position of the braking system.

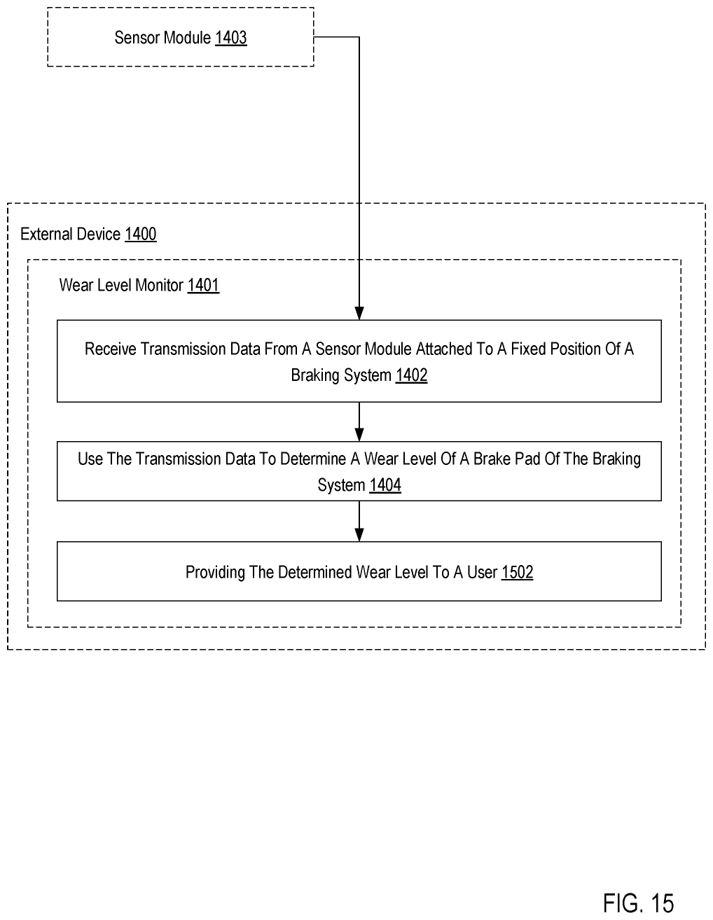

For further explanation, FIG. 15 sets forth a flowchart of an example method for brake pad wear level monitoring in accordance with at least one embodiment of the present disclosure. The method of FIG. 15 includes elements of FIG. 14. In addition, the method of FIG. 15 includes providing (1502), by the wear level monitor (1401), the determined wear level to a user. Providing (1502), by the wear level monitor (1401), the determined wear level to a user may be carried out by displaying the determined wear level on a screen of the external device; and transmitting the determined wear level to another device that is accessible by the user.

In view of the explanations set forth above, readers will recognize that the benefits of brake pad wear level monitoring according to embodiments of the present disclosure include, but are not limited to:
The brake pad wear level monitoring sensor is battery operated;
Eliminates costly wire harness for power and communication;
Provides continuous position measurements via a wireless transmission to a detached receiver;
Fully ‘non-contacting’ operation which eliminates wear interfaces (extending life of sensor) and does not induce external forces onto brake system;
Easy integration into applications where position measurement is required or desired, especially in fixed caliper systems;
Sensor is non-consumable, such that sensor assembly is removable and can be re-used after brake pads, or caliper components, have been serviced and/or replaced;
Smart RF transmission capability for extended battery life (customizable transmission protocols and frequencies (e.g. 433.92/315 MHz RKE, Bluetooth Low Energy (BLE), Thread protocol etc.) based on application requirements); and
Extended life expectancy of the sensor.

Exemplary embodiments of the present invention are described largely in the context of a fully functional computer system for brake pad wear level monitoring. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, apparatuses, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. An apparatus for brake pad wear level monitoring, the apparatus including: a sensor module attached to a fixed portion of a braking system, the sensor module configured to: generate data indicative of a relative distance between the sensor module and a sensor target attached to a brake pad; use the generated data to generate transmission data; and transmit the generated transmission data to an external device.

2. The apparatus of statement 1 wherein generating data indicative of a relative distance between the sensor module and a sensor target attached to a brake pad includes: sensing, by a sense element of the sensor module, a magnetic field strength of a magnet of the sensor target attached to the brake pad; and generating, by the sense element, a signal indicating the sensed magnetic field strength.

3. The apparatus of statement 1 or 2 wherein using the generated data to generate transmission data includes using the generated signal to generate the transmission data.

4. The apparatus of any of statements 1-3 wherein the sense element includes at least one of a magneto resistive element, an inductive element, and two or more low-power resistive bridge elements.

5. The apparatus of any of statements 1-4 wherein the sensor target is configured for attaching to a brake pad backing plate of the brake pad.

6. The apparatus of any of statements 1-5 wherein using the generated data to generate transmission data includes: using the generated data to determine a wear level of the brake pad; and including within the generated transmission data, an indication of the determined wear level of the brake pad.

7. The apparatus of any of statements 1-6 wherein the sense module is further configured to: generate, by a temperature sensor of the sensor module, temperature data for the fixed portion of the braking system; use the temperature data to generate a temperature transmission data; and transmit the temperature transmission data.

8. An apparatus for brake pad wear level monitoring, the apparatus including a computer processor coupled to a non-transitory computer readable storage medium that includes computer program instructions that when executed by the computer processor cause the apparatus to carry out the operations of: receiving, by a wear level monitor, transmission data from a sensor module attached to a fixed position of a braking system; and using, by the wear level monitor, the transmission data to determine a wear level of a brake pad of the braking system.

9. The apparatus of statement 8 wherein the non-transitory computer readable storage medium further includes computer program instructions that when executed by the computer processor cause the apparatus to carry out the operations of: displaying, by the wear level monitor, the determined wear level.

10. The apparatus of any of statements 8-9 wherein the transmission data includes position data indicating a relative distance between the sensor module and a sensor target attached to a brake pad.

11. The apparatus of any of statements 8-10 wherein the transmission data includes a wear level data indicating a wear level of the brake pad.

12. A method of brake pad wear level monitoring, the method comprising: generating, by a sensor module attached to a fixed portion of a braking system, data indicative of a relative distance between the sensor module and a sensor target attached to a brake pad; and using, by the sensor module, the generated data to determine a wear level of the brake pad.

13. The method of statement 12 wherein generating data indicative of a relative distance between the sensor module and a sensor target attached to a brake pad includes: sensing, by a sense element of the sensor module, a magnetic field strength of a magnet of the sensor target attached to the brake pad; and generating, by the sense element, a signal indicating the sensed magnetic field strength.

14. The method of any of statements 12-13 wherein using the generated data to determine a wear level of the brake pad includes: using, by a processor of the sensor module, the signal to determine the wear level of the brake pad.

15. The method of any of statements 12-14 wherein the sense element includes at least one of a magneto resistive element, an inductive element, and two or more low-power resistive bridge elements.

16. The method of any of statements 12-15 wherein the sensor target is configured for attaching to a brake pad backing plate of the brake pad.

17. The method of any of statements 12-16 further comprising: generating a wear level value indicating the determined wear level of the brake pad.

18. The method of any of statements 12-17 further comprising: wirelessly transmitting, by the sensor module, the generated wear level value to an external device.

19. A method for brake pad wear level monitoring, the method comprising: receiving from a sense element of a sensor module, by a wear level monitor of the sensor module, data indicative of a relative distance between the sensor module and a sensor target attached to a brake pad; and using, by the wear level monitor, the received data to determine a wear level of the brake pad.

20. The method of statement 19 wherein receiving from a sense element of a sensor module, by a wear level monitor of the sensor module, data indicative of a relative distance between the sensor module and a sensor target attached to a brake pad includes: receiving a signal generated by the sense element, the signal indicating a measurement of a magnetic field strength of a magnet of the sensor target.

21. The method of any of statements 19-20 wherein using the generated data to determine a wear level of the brake pad includes: using the signal to determine the wear level of the brake pad.

22. The method of any of statements 19-21 further comprising: generating, by the wear level monitor, a wear level value indicating the determined wear level of the brake pad.

23. The method of any of statements 19-22 further comprising: wirelessly transmitting, by the wear level monitor, the generated wear level value to an external device.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

1. An apparatus for brake pad wear level monitoring, the apparatus including:
a sensor module attached to a fixed portion of a braking system, the sensor module configured to:
generate data indicative of a relative distance between the sensor module and a sensor target attached to a brake pad;
use the generated data to generate transmission data; and
transmit the generated transmission data to an external device.

2. The apparatus of claim 1 wherein generating data indicative of a relative distance between the sensor module and a sensor target attached to a brake pad includes:
sensing, by a sense element of the sensor module, a magnetic field strength of a magnet of the sensor target attached to the brake pad; and
generating, by the sense element, a signal indicating the sensed magnetic field strength.

3. The apparatus of claim 2 wherein using the generated data to generate transmission data includes using the generated signal to generate the transmission data.

4. The apparatus of claim 2 wherein the sense element includes at least one of a magneto resistive element, an inductive element, and two or more low-power resistive bridge elements.

5. The apparatus of claim 1 wherein the sensor target is configured for attaching to a brake pad backing plate of the brake pad.

6. The apparatus of claim 1 wherein using the generated data to generate transmission data includes:
using the generated data to determine a wear level of the brake pad; and
including within the generated transmission data, an indication of the determined wear level of the brake pad.

7. The apparatus of claim 1 wherein the sense module is further configured to:
generate, by a temperature sensor of the sensor module, temperature data for the fixed portion of the braking system;
use the temperature data to generate a temperature transmission data; and
transmit the temperature transmission data.

8. An apparatus for brake pad wear level monitoring, the apparatus including a computer processor coupled to a non-transitory computer readable storage medium that includes computer program instructions that when executed by the computer processor cause the apparatus to carry out the operations of:
receiving, by a wear level monitor, transmission data from a sensor module attached to a fixed position of a braking system; and
using, by the wear level monitor, the transmission data to determine a wear level of a brake pad of the braking system.

9. The apparatus of claim 8 wherein the non-transitory computer readable storage medium further includes computer program instructions that when executed by the computer processor cause the apparatus to carry out the operations of:
displaying, by the wear level monitor, the determined wear level.

10. The apparatus of claim 8 wherein the transmission data includes position data indicating a relative distance between the sensor module and a sensor target attached to a brake pad.

11. The apparatus of claim 8 wherein the transmission data includes a wear level data indicating a wear level of the brake pad.

12. A method of brake pad wear level monitoring, the method comprising:
generating, by a sensor module attached to a fixed portion of a braking system, data indicative of a relative distance between the sensor module and a sensor target attached to a brake pad; and
using, by the sensor module, the generated data to determine a wear level of the brake pad.

13. The method of claim 12 wherein generating data indicative of a relative distance between the sensor module and a sensor target attached to a brake pad includes:
sensing, by a sense element of the sensor module, a magnetic field strength of a magnet of the sensor target attached to the brake pad; and
generating, by the sense element, a signal indicating the sensed magnetic field strength.

14. The method of claim 13 wherein using the generated data to determine a wear level of the brake pad includes:
using, by a processor of the sensor module, the signal to determine the wear level of the brake pad.

15. The method of claim 12 wherein the sense element includes at least one of a magneto resistive element, an inductive element, and two or more low-power resistive bridge elements.

16. The method of claim 12 wherein the sensor target is configured for attaching to a brake pad backing plate of the brake pad.

17. The method of claim 12 further comprising:
generating a wear level value indicating the determined wear level of the brake pad.

18. The method of claim 12 further comprising:
wirelessly transmitting, by the sensor module, the generated wear level value to an external device.

19. A method for brake pad wear level monitoring, the method comprising:
receiving from a sense element of a sensor module, by a wear level monitor of the sensor module, data indicative of a relative distance between the sensor module and a sensor target attached to a brake pad; and
using, by the wear level monitor, the received data to determine a wear level of the brake pad.

20. The method of claim 19 wherein receiving from a sense element of a sensor module, by a wear level monitor of the sensor module, data indicative of a relative distance between the sensor module and a sensor target attached to a brake pad includes:
receiving a signal generated by the sense element, the signal indicating a measurement of a magnetic field strength of a magnet of the sensor target.

21. The method of claim 20 wherein using the generated data to determine a wear level of the brake pad includes:
using the signal to determine the wear level of the brake pad.

22. The method of claim 19 further comprising:
generating, by the wear level monitor, a wear level value indicating the determined wear level of the brake pad.

23. The method of claim 19 further comprising:
wirelessly transmitting, by the wear level monitor, the generated wear level value to an external device.
